(19) United States
(12) Patent Application Publication
(10) Pub. No.: US 2006/0274764 A1
(43) Pub. Date: Dec. 7, 2006

(54) Power saving methods in gateway

(76) Inventors: Donald T. Mah, Trabuco Canyon, CA (US); Matthew McRae, Laguna Beach, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/143,344

(22) Filed: Jun. 2, 2005

(51) Int. Cl. H04L 12/56

(52) U.S. Cl. 370/401

(57) ABSTRACT

When a gateway detects that power from a primary power supply is disrupted or unavailable, reserve power, such as from batteries, is provided only to those components, ports, interfaces, and circuits associated with the gateway that are required for making a voice call or a lifeline call.

### BACKGROUND

1. Field of Invention

The present invention relates generally to wireless devices, such as gateways, and more particularly to methods of providing power to such devices.

2. Related Art

Broadband and Voice over Internet Protocol (VoIP) telephone services are becoming more and more prevalent in today's communications. VoIP allows voice calls using Internet Protocol (“IP”) networks, such as the Internet, corporate intranets, or any IP network, as an alternative to traditional public switched telephone networks (“PSTN”). Unlike the PSTN, which is circuit-switched, the Internet is packet-switched. As such, communication on the Internet is accomplished by transmitting and receiving packets of data. In addition to data, each packet contains a destination address to ensure that it is routed correctly. The format of these packets is defined by the IP. One type of allowable data is encoded, digitized voice, known as Voice over IP. VoIP is voice that is packetized as defined by IP, and communicated over the Internet for telephone-like communication. Individual VoIP packets may travel over different network paths to reach the final destination where the packets are reassembled in correct sequence to reconstruct the voice information.

As broadband penetration continues to rise, device manufacturers and service providers are looking towards more highly integrated consumer premises equipment (CPE). These integrated gateways take on additional functions beyond broadband service, such as wireless connectivity and voice services.

It becomes necessary for a certain guaranteed level of service to be provided, as is the case with primary line voice communications. The device must be able to continue operating during a power failure or disruption to ensure voice services in an emergency, as mandated by some governmental agencies. Conventional methods provide for a battery backup to be used to supply power to the device during power failures. This then enables the user to place emergency calls through the device even when a power failure has occurred.

However, as communication networking and systems become increasingly more complex, with more and more components coupled to and controlled by the gateway, the gateway will need much more power than a simple modem EMTA (Embedded Multimedia Terminal Adapter). Because of the additional power requirements, a limited reserve power supply, such as batteries, may become depleted very quickly during extended periods of power failures and phone use. As a result, emergency or lifeline calling may not be possible, as connectivity to necessary components is no longer maintained due to lack of power to those components.

While VoIP provides numerous advantages over the PSTN or Plain Old Telephone Service (POTS), such phone systems also present certain problems not associated with conventional telephone systems. For example, because communication is effected through the Internet, a power failure can interrupt or prevent VoIP service. While such problems may be acceptable for purposes of data transmission and most voice communications, it is generally unacceptable for certain types of voice of communications, such as emergency or 911 calls. In the event of a power outage, the user will be unable to place calls over the VoIP phone system. The user would then need to place the emergency call through another channel, such as a cell phone or a conventional land line phone. Even if such a channel were available, which may not always be the case, valuable time may be lost in placing the emergency call.

Therefore, there is a need for a device and method used in a broadband system that allows emergency lifeline calling over the VoIP network and overcomes the disadvantages of conventional devices and methods discussed above.

### BRIEF DESCRIPTION OF THE DRAWINGS

FIG. 1 is a block diagram of a basic networked communication system using a gateway according to one embodiment of the present invention;

FIG. 2 is a block diagram of the gateway of FIG. 1 according to one embodiment; and

FIG. 3 is a flowchart illustrating an algorithm for supplying power to components and ports of the gateway of FIGS. 1 and 2 according to one embodiment.

Embodiments of the present invention and their advantages are best understood by referring to the detailed description that follows. It should be appreciated that like reference numerals are used to identify like elements illustrated in one or more of the figures.

### DETAILED DESCRIPTION

According to one embodiment of the present invention, when a power outage or disruption is detected, power is shut down to components, devices, and services that are not required for phone service. For example, components that are shut down can include local area network (LAN) circuitry and ports. Reserve power, such as through a battery, is supplied only to components and ports needed to continue or facilitate voice communication, such as Voice over Internet Protocol (VoIP) components and ports.

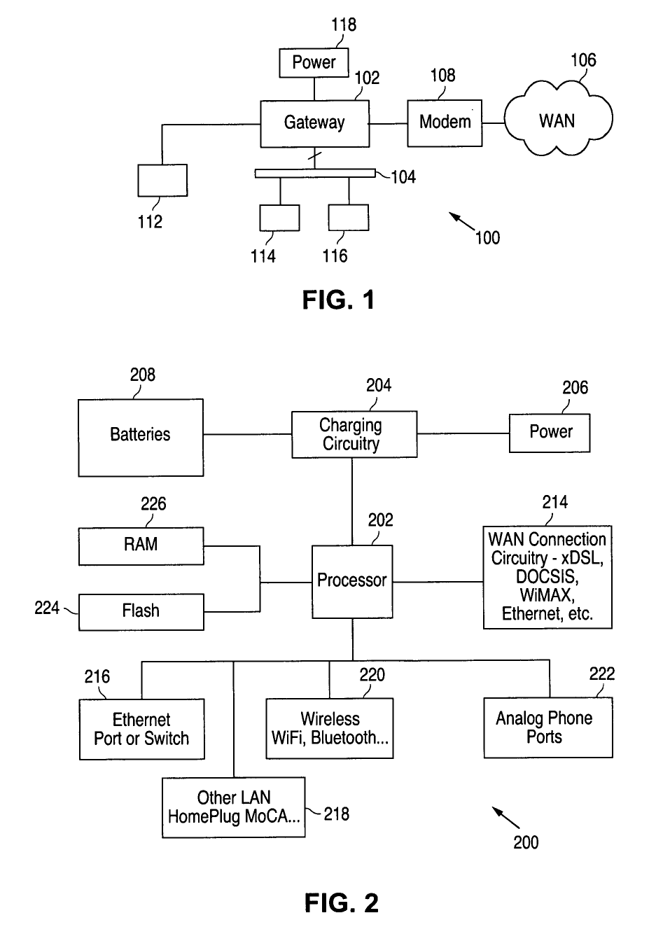

FIG. 1 is a block diagram of a networked communication system 100 according to one embodiment. Communication system 100 includes a gateway 102 having ports connectable to a LAN 104 and a Wide Area Network (WAN) 106 or the Internet for packetized communication. WAN 106 can be connected to gateway 102 through a broadband modem 108 by an Internet protocol. In one embodiment, modem 108 is embedded within gateway 102. Gateway 102 may also have one or more ports for connection to one or more analog phones or VoIP phones 112. Network devices 114 and 116 are connected to gateway 102 directly by LAN 104. Network devices 114 and 116 can be LAN devices, such as a personal computer (PC), print server, and hard drives. Although two terminals 114 and 116 are shown, gateway 102 can accommodate both higher and lower numbers of terminals. Power is provided to gateway 102 by a main power supply 118, such as an AC or DC power source.

According to one aspect of the present invention, when gateway 102 detects that main power supply 118 has stopped providing power, gateway 102 terminates power to LAN components and interfaces, such as network devices 114 and 116. Gateway 102 draws power from a reserve power supply and provides that power to WAN components and interfaces needed to make VoIP calls, such as lifeline calling. As a result, power consumption from the reserve power supply is conserved so that lifeline calling is possible for extended periods of time. Additional details are provided below.

FIG. 2 is a block diagram of an exemplary device, such as an access point or gateway 200, which can be used as gateway 102 of FIG. 1. One example of a suitable gateway is the WCG200 from Linksys. Gateway 200 includes a processor 202 coupled to a power interface or a charging circuit 204. Charging circuit 204 provides power from either a main power supply 206, such as from a power socket from a wall in a house, or a reserve power supply 208, such as one or more batteries, to processor 202. Charging circuit 204 can be any conventional circuit, such as ones used for battery/AC power in computer notebooks. Reserve power supply 208 or batteries may be fully embedded within the gateway, external to the gateway, or removable by the user. When charging circuit 204 detects a power outage, such as when power from main power supply 206 drops below a threshold level, charging circuit 204 begins to draw power from reserve power supply 208.

In normal operation, power is provided through main power supply 206. Processor 202, through charging circuit 204, supplies power to various components and ports of gateway 200. Typically, gateway 200 includes at least one port or component for wide area network (WAN) connection and at least one port or component for local area network (LAN) connection.

On the WAN side, gateway 200 has a WAN interface 214, which can be a modem, serial port, DSL, or an Ethernet port as the WAN connection to a cable modem or DSL modem. WAN interface 214 can include an embedded broadband modem, which could be xDSL (e.g., ADSL, HDSL, VDSL, and SDSL), DOCSIS (Data over Cable Service Interface Specification), WiMAX, Ethernet, and other WAN connection types. It

On the LAN side, gateway 200 could include an Ethernet port or switch 216 for allowing connectivity to LAN devices. Gateway 200, in some embodiments, may also include interfaces to or components for other wired LAN networking technologies 218, such as MoCA (Multimedia over Coax Alliance) or HomePlug® (e.g., conformant to the 1.0 and AV specifications). Gateway 200 may also have an interface or an access point to provide connectivity to various wireless technologies 220, such as 802.11, Wi-Fi®, Bluetooth®, and UWB (Ultra Wideband).

Gateway 200 also includes one or more analog phone ports 222 to provide voice service through analog phone devices. A Voice over IP (VoIP) technology, such as Media Gateway Control Protocol (MGCP) and the Session Initiation Protocol (SIP), within gateway 200 can be used to connect to a phone or analog voice device.

In one embodiment, gateway 200 includes memory, such as flash memory 224 and random access memory (RAM) 226 coupled to processor 202. Processor 202 is capable of writing to and reading from flash memory 224 and RAM 226 as needed for operation of the gateway and to enable the user to communicate through the various devices connected to the gateway, such as VoIP phones.

When power is provided through main power supply 206, processor 208 routes or controls power to all components and ports needed for communication. For example, power can be provided to analog phone ports 222 to enable VoIP communication, to Ethernet port 216 for wired communication, and to components for 802.11 communication, as well as to flash memory 224, RAM 226, and WAN connection circuitry 214.

However, when charging circuit 204 detects a power outage or disruption to main power supply 206, charging circuit 204 draws power from reserve power supply 208. When this happens, charging circuit 204 transmits a signal to processor 202 to indicate that power is no longer being provided by main power supply 206. Processor 202 then continues to route or control power to WAN connection circuitry 214, flash memory 224, RAM 226, and analog phone port 222 to enable the system to maintain communication, such as for emergency 911 calls. Other components and ports are shut down or placed into a power saving mode by processor 202, thereby conserving power and allowing power to be maintained for a longer period to the VoIP components. Gateway 200 may be user configurable to leave some interfaces on, such as Ethernet port 216 for data communication. However, in these situations, available power from reserve power 208 may deplete sooner, which may necessitate a more judicious control on which non-essential ports or components are provided reserve power. In another embodiment, once a power outage is detected, processor 202 transmits a signal to all components and ports indicating a power outage has occurred and that reserve power will be used. Those devices can then respond accordingly, such as suspending the running of certain non-crucial applications that may require significant power, such as system clean-ups. Accordingly, gateway 200 also implements routing and runs software to enable functions described herein.

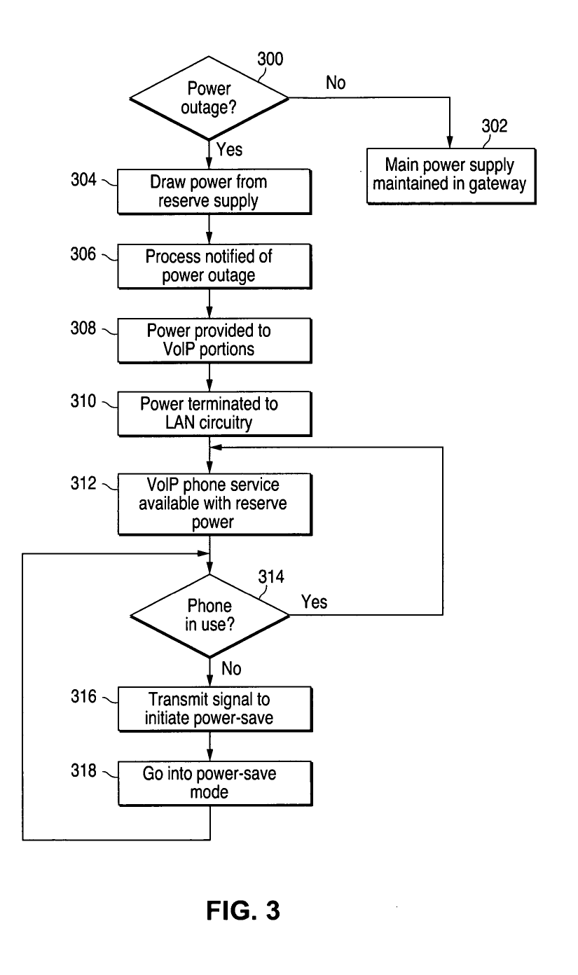

FIG. 3 is a flowchart illustrating a power-saving process according to one embodiment of the invention. In operation 300, the gateway determines whether a power outage or disruption has occurred. This can, for example, be accomplished using a comparator circuit, such as an operational amplifier, to compare the measured voltage from a power supply, such as a power outlet, to a threshold voltage. If the measured voltage drops below the threshold voltage, a power outage is indicated. The comparison period can be any suitable time. If there is no determination of a power outage, the gateway continues providing power, in operation 302, to ports, sections, and components from the main power supply. However, if, as determined in operation 300, power from main power supply has been disrupted or is out, the gateway begins drawing power from a reserve power supply, such as batteries, in operation 304. As a result, there is no disruption to power to the gateway, and the gateway can continue its functions.

Next, in operation 306, the processor in the gateway is notified of the power disruption to the main power supply. This indicates to the processor that power is being delivered from a reserve power supply and to initiate a power-saving protocol. In one embodiment, the power-saving protocol only provides power to ports or components of the gateway needed for VoIP phone service or configured to remain powered up, in operation 308, so that emergency calling or lifeline service is available. For example, reserve power can be supplied to memory, such as RAM and Flash memory, WAN connection circuitry, and analog or VoIP phone ports and components.

In other embodiments, to further conserve the reserve power supply, components needed for VoIP service, including the processor, can go into a power-save or sleep mode when inactive, e.g., when the phone is not in use. A signal from the processor that power is being delivered from the reserve supply could also initiate the various sleep functions of the affected VoIP portions. Other non-essential components of the gateway could also have their power terminated or reduced, such as displays and LEDs. In addition to initiating a sleep function, the signal from the processor may also cause certain applications or functions to be suspended until the main power is returned. These applications or functions may include ones that are not required for user communication or use excessive amounts of power, which would quickly deplete the reserve power supply. Excessive or substantial amounts of power can be based on various factors, such as a user defined level and time, the type of reserve power supply, the estimated time and power requirements of the application, the estimated time to replace the reserve power supply, and/or the estimated time for the main power supply to be available.

While VoIP portions are being supplied full or reduced power from the reserve power supply, power to LAN circuitry, ports, and components, such as Ethernet ports and switches, and wireless ports and circuitry, such as WiFi®, Bluetooth®, HomePlug®, and MoCA, is terminated or shut down in operation 310 unless programmed to maintain power. The shut-down procedure can be with any suitable conventional method. For example, the processor may stop providing power to the affected portions of the gateway. The processor may also send a signal to specific portions of the gateway to initiate a sleep function or other power reducing mechanism, if such devices or components have them.

If the gateway has analog VoIP ports, with a lifeline phone attached to an RJ-11 port, the gateway terminates reserve power to LAN networking circuitry (operation 310), while providing reserve power to WAN connection circuitry (operation 308). If the gateway has a phone connected to a LAN port, with or without VoIP ports, the gateway provides reserve power to WAN connection circuitry (operation 308) and terminates reserve power to LAN networking circuits not needed for VoIP (operation 310), which may include some LAN circuitry. For example, if a WiFi phone is connected to the gateway and the user desires to continue WiFi phone usage during a power outage, the gateway would provide reserve power to wireless LAN circuits needed for WiFi phone operation. Other LAN ports without phones would have their power terminated or placed into a power-save mode.

In another embodiment, instead of terminating power to all LAN circuitry, the gateway may allow the user to specify which components are to be shut down or have reduced power supplied in the event of a main power disruption. For example, if the user wants to continue using a WiFi or other wireless phone handset during a power outage, the processor could continue to provide reserve power to wireless LAN circuitry needed to operate the WiFi phone. The termination, shut-down, or power reduction can be accomplished within the processor by software or hardware controls, as is known by those skilled in the art.

With power terminated or reduced to areas of the gateway not needed for VoIP service, the reserve power is conserved. Reserve power is still provided to those portions of the gateway needed for VoIP service or other phone service so that emergency, lifeline, or other calls can still be made. Thus, VoIP or another phone service is available using reserve power in operation 312.

In another embodiment, reserve power can be further conserved by placing LAN or VoIP portions in a sleep mode when the phone is not in use or inactive. The gateway determines, in operation 314, whether the phone is in use. If so, the phone continues operation, such as with VoIP service, using reserve power in operation 312. However, if the phone is not in use, the gateway transmits a signal, in operation 316, to LAN or VoIP portions to initiate a power-save or sleep mode process if supported. In response, those portions having a power-save mode go into the power-save or sleep mode in operation 318.

Thus, available portions, including the processor, may go into a power save or sleep mode in operation 318 when the phone is not in use. Once the phone is back in use, the processor provides reserve power to “wake” up these portions. As a result, the gateway conserves additional reserve power during times when the phone is not in use. When power from the main power supply is detected, the gateway resumes normal operation with power from the main power supply provided to the gateway components. Then, the portions of the gateway that were either shut down, placed in sleep mode, or provided with reduced power are then re-initialized with power from the main power supply.

Thus, the gateway's power and power control sections are designed such that power delivery to individual portions of the gateway or system is selectively isolated. Firmware would be able to control the power to those sections and at a later time reboot or re-initialize the section of the device. The firmware is sufficiently robust to continue functioning in areas of WAN connectivity and VoIP without the other portions of the gateway responding. Accordingly, the life of the reserve power supply, such as batteries, is maximized to provide lifeline VoIP services for as long as possible because only portions of the device necessary to provide this service are powered during a power disruption.

Having thus described embodiments of the present invention, persons skilled in the art will recognize that changes may be made in form and detail without departing from the scope of the invention. For example, other variations of power reduction are also within the scope of the invention, such as reducing transmit power levels on a VoIP phone and reducing or eliminating remote management functionality. Further, once a power disruption from the main power supply is detected, the gateway can first transmit a signal to all components, circuits, and chips that have some type of power-save or sleep mode. This then puts those portions into a power-save mode. Other portions of the gateway are then either supplied full reserve power, a reduced reserve power, or no reserve power, as discussed above. Thus the invention is limited only by the following claims.

What is claimed is:

1. A method of providing power to specific portions of a gateway having Local Area Network (LAN) and Wide Area Network (WAN) interfaces and components and a reserve power supply, the method comprising:
detecting whether power from a main power supply to the gateway has been disrupted; and
supplying power from the reserve power supply only to portions of the gateway needed to make a voice call when power from the main power supply has been disrupted.

2. The method of claim 1, further comprising supplying a reduced power from the reserve power supply to the LAN interfaces and components.

3. The method of claim 2, wherein the reduced power is zero power.

4. The method of claim 1, further comprising placing ones of the LAN and WAN interfaces and components having a power-saving mode into the power-saving mode when power from the main power supply has been disrupted.

5. The method of claim 4, wherein the power-saving mode comprises a sleep mode.

6. The method of claim 4, wherein the power-saving mode comprises a low power mode.

7. The method of claim 2, wherein supplying the reduced power comprises transmitting a signal to the LAN interfaces and components to initiate a power reduction process.

8. The method of claim 1, wherein the voice call is Voice over Internet Protocol (VoIP) calling.

9. The method of claim 1, further comprising placing the portions in a power-save mode when no voice calls are being made.

10. The method of claim 2, further comprising re-initializing the LAN interfaces and components when power resumes from the main power supply.

11. The method of claim 1, wherein the voice call is a WiFi phone call.

12. The method of claim 1, wherein the detecting comprises comparing a voltage from the main power supply to a reference voltage.

13. The method of claim 1, further comprising suspending applications that are non-essential and require substantial power.

14. A gateway for a communication network having WAN and LAN ports, comprising:
a reserve power supply;
a detection circuit coupled to the reserve power supply and a main power supply for detecting when power from the main power supply is disrupted;
and
a processor coupled to an output of the detection circuit, wherein the processor is configured to provide power from the reserve power supply to ports needed for voice calling when power from the main power supply is disrupted.

15. The gateway of claim 14, wherein the processor is further configured to provide a reduced power from the reserve power supply to LAN ports not needed for voice calling when power from the main power supply is disrupted.

16. The gateway of claim 14, wherein the voice calling is VoIP calling.

17. The gateway of claim 15, wherein the reduced power is zero.

18. The gateway of claim 14, wherein the voice calling is WiFi calling.

19. A circuit for providing power to specific portions of a gateway having Local Area Network (LAN) and Wide Area Network (WAN) interfaces and components, the circuit comprising:
means for detecting whether power from a main power supply to the gateway has been disrupted; and
means for supplying power from a reserve power supply only to portions of the gateway needed to make a voice call when power from the main power supply has been disrupted.
